(19) United States
(12) Patent Application Publication
(10) Pub. No.: US 2012/0130801 A1
(43) Pub. Date: May 24, 2012

(54) SYSTEM AND METHOD FOR MOBILE ADVERTISING

(76) Inventors: Victor Baranov, Toronto (CA); Vladimir Smychok, Tomsk (RU)

(21) Appl. No.: 13/114,441

(22) Filed: May 24, 2011

Related U.S. Application Data
(60) Provisional application No. 61/396,541, filed on May 27, 2010.

(51) Int. Cl. G06Q 30/02

(52) U.S. Cl. 705/14.43

(57) ABSTRACT

System and method for advertising on mobile devices, wherein an application installed on the device is linked with a device side component capable of requesting an advertisement, displaying the advertisement, and reporting the user reaction to the advertisement, assisted by an advertising server, such that the effort to implement advertisement support on the part of the application developer may be reduced (e.g., minimized) compared to other typical advertising systems and methods.

### CROSS-REFERENCE TO RELATED APPLICATION

The present application claims the benefit of U.S. (Provisional) Application No. 61/396,541, filed May 27, 2010, the contents of which are incorporated herein by reference in their entirety.

### FIELD

The present disclosure relates to mobile wireless devices, and in particular to the delivery of advertising content to applications running on such devices, the presentation of the advertising content on the devices, and to the integration of the advertising content into the applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many modern mobile wireless devices feature hardware capabilities approaching those of personal computers. Such capabilities include powerful central processors, high-performance graphics subsystems, high-resolution screens, a variety of wireless technologies, high capacity storage and operational memory, electronics for geographical location acquisition, accelerometers, cameras, and so on. Mobile devices having these capabilities are often referred to as “smartphones”, to emphasize the two functions such devices are typically designed for, i.e. the phone functionality, and a set of “smart” features that makes the devices resemble general-purpose programmable personal computing devices.

Smartphones, being essentially general-purpose programmable machines, can run a multitude of programs, many of which may be categorized as “applications”, that is, programs with which users interact. Users may interact with such applications through a graphical user interface (GUI), typically comprised of a screen for information display and one or more input methods, such as a keypad, a touch input method (such as a capacitive or resistive touch screen), a stylus, an accelerometer, a camera, a microphone, etc. The term “application” also refers to the idea that such a computer program may have a particular utilitarian applicability, be it a text processing program, a calculator, a mapping program, or even a game.

Applications for the smartphones may be designed and built by many different software development entities, including corporations and individual developers, each using a variety of approaches and development design tools.

The current mobile wireless device market offers a wide variety of smartphone device brands and models, each potentially varying markedly in both hardware and software capabilities.

The smartphone capabilities in the hardware domain are reflected in the software domain by way of the operating system (OS). Through the use of OS programming models, the developers may build and create new applications without concern for every possible hardware configuration.

Software developers often do not access hardware capabilities directly; and instead may build applications using a set of application programming interfaces (API) made available by the OS.

Due in part to the competitiveness of the electronic mobile wireless device market, the smartphones produced by different hardware vendors often feature substantially different operating systems and corresponding programming models and languages supported by these operating systems.

The hardware and software landscape of the existing smartphone market is thus very fragmented. Developers of application programs are faced with difficult choices as to which hardware and software smartphone solutions to address in their designs. It may not be feasible for individual developers or even corporations to develop applications for all or even a few of the many existing smartphone brands and models.

Existing mobile application distribution models often feature an “application store” for the various smartphone OS types or device brands. Many vendors, as well as many wireless communications operators, offer their own proprietary application stores, with their own rules, restrictions, fees, audiences, etc. An application store is an online service accessible to users via a program running on smartphones, and accessible to application developers via a special web site, typically named “application developer portal”.

Many such application stores have thousands of applications offered to users for purchase and download to their smartphone devices, with some application stores featuring tens or even hundreds of thousands of applications.

User-accessible application stores often offer application search and directory capabilities, such that an application of interest may be found by entering a keyword or looking it up in a thematically grouped application catalogue. However, due to the large number of applications, it may be very difficult for developers to make their applications stand out from hundreds or thousands of similar applications developed by other companies or individuals.

Thus, a large number of similar-purpose applications in the application stores makes it very difficult to successfully commercialize the applications because the total amount of monetary compensation received from users is distributed over many application developers.

Additionally, applications sold through application stores are typically priced very low such that the resulting monetary compensation for many developers cannot support software development practices, effectively making them commercially untenable.

These hurdles in monetizing mobile applications compel application developers to look for compensation elsewhere, with one of the choices being advertising.

There are many businesses involved with mobile advertising. Some businesses are oriented towards the advertiser side and some towards the developer side, with some businesses offering varying levels of support to both the advertiser and developer. For example, a business involved with mobile advertising may be an advertising network company or an aggregator company that combines several advertising sources into one flow of advertisements towards the “publisher” side, as they refer to application developers, among others, in this professional domain.

Such a business entity often offers application developers a software development kit (SDK), or an API, that can be integrated into applications the developers are creating.

The API as used in this context may refer to a set of rules for forming a uniform resource locator (URL) for an advertising request, such that the developers can supply a variety of parameters into the advertising request, and thus influence the relevance of the resulting advertising banner, text, or other kind of media carrying advertising content.

The SDK as used in this context may refer to a set of binary components along with documentation and samples of its use. The binary components typically provide a developer-friendly API for creating advertising request URLs, and GUI components capable of displaying an advertising banner, text or multimedia content in the screen position and area specified by the application developer, and at a time appropriate from an application integration point of view, such that the program logic flow is not disrupted.

Advertising networks often have certain rules of engagement for application developers. These rules may often be necessary because they help verify the developer is legitimate, the application is not going to abuse the advertising system, and the application is well designed. The rules can also help to protect users from the display of excessive or inappropriate advertising, application or device instability or poor performance. The engagement rules followed by advertising networks can lead to a developer and application verification time period of up to one month or more.

Advertising networks may also often impose a minimum on the number of ad impressions or clicks over a period of time, typically per month; this is necessary for the advertising networks to justify the costs associated with providing the developer SDK or API and for regular support services associated with technical issues and processing of payments. If the developer is unable to provide the required minimum volume of impressions or clicks, then his application may not be permitted to participate in the advertising network. Thus, a developer faced with the inability to meet the advertising network imposed minimum is unable to use the advertising network as a source of income.

So the developer that has not yet gained a sufficient volume of downloads of his application by users may be faced with several substantial difficulties in getting advertisement support built into his applications. Examples include:

a) Integration of the typical advertising SDKs or APIs offered by advertising networks require developers to make changes in the design of the applications, coding these changes into the application, debugging the changes, and testing the changes.

b) The advertising SDK are in many cases platform-dependent, so the developer may be required to modify the application for each smartphone device platform of interest, including adjustments of the application screens for each brand and model of interest.

c) Many advertising networks do not offer SDK or API support for all the available smartphone device platforms. Therefore, the developer interested in multiple device platforms may be faced with the need to work with more than one advertising network.

d) The application developer may be unable to meet the minimum advertising impressions or clicks volume threshold and thus unable to become engaged with an advertising network of interest.

e) Advertising business knowledge, its terminology, and its current practices may be unfamiliar to the application developer, thus making him feel foreign to the whole advertising subject and so constrain the developer to stay away from advertising completely.

f) Engagement with advertising networks may take a significant amount of time as each new version of the applications are subjected to verification requirements. In addition to the verification time resulting from engaging advertising networks, additional time must be accounted for in submitting (and/or resubmitting) the applications to the application stores and having the applications approved. Additional time must also be taken into account in considering the number of smartphone device platforms that the developer is willing to address with his application, because the applications may need to be resubmitted to different applications stores for different device platforms. This may be especially pertinent to cross-platform applications, where the applications require communication between each other and compatibility of their exchange protocol versions, and therefore may need to be updated nearly simultaneously.

g) Advertising networks may change their API or SDK as they see fit. When changes occur, application developers engaged with the advertising network may need to upgrade their applications to either stay compatible with the advertising network, or to take advantage of bug fixes or new features offered by the advertising network.

h) Advertising networks may be unable, for either technical or business reasons, to provide adequate protection against possible click or impressions fraud. The inability to protect against fraud negatively affects the prices for clicks and impressions, and as such, not only makes advertising networks suspicious of new developers, but also reduces effective payouts to developers by advertisers.

Faced with these difficulties, many developers, especially small companies and individuals, either have no way to get involved in mobile advertising business, or are unable to receive substantial income from such engagements.

As a result, many application developers, having no clear path to monetize their application development efforts, either reduce the scope of their work, or completely abandon application development for mobile devices.

For these reasons, a need exists for a solution that is capable of sorting out one or more of the above mentioned difficulties.

Accordingly, it is desirable to provide a simplified way for mobile application developers to integrate advertising in their software applications, and as such, to take part in advertising revenues.

### SUMMARY OF THE INVENTION

At least one aspect of one or more embodiments of the present invention provides an advertising system or an advertising content display (ACD) system and associated methods. The ACD system may provide mechanisms for displaying advertisements on smartphone device screens. Hereinafter, the terms ‘advertising system’ or ‘ACD system’ may be interchangeably used, and it is to be understood that they refer to the same thing.

In some embodiments, an advertising system for advertising on a computing device, for example a mobile device, is provided. The advertising system includes a developer input module that is configured to receive advertisement configuration inputs corresponding to an application from an application developer. The advertising system also includes an advertising profile generation module that generates an advertising profile associated with the application. The advertising system includes a software development kit (SDK) generation module configured to generate an SDK, such that the SDK enables display of one or more advertising content on the mobile device. The advertising content is displayed via the application when the SDK is incorporated into the application and the application is installed on the mobile device.

The advertising system also includes an advertisement-request receiving module configured to receive requests for supplying the one or more advertising content to the mobile device. The requests for the one or more advertising content is received from the SDK of the installed application on occurrence of an event during activity of the installed application. Thereafter, an advertisement-supplying module sends the one or more advertising content to the mobile device based on the advertising profile associated with the application.

The advertising system also includes an interaction-receiving module that receives one or more parameters from the mobile device. The one or more parameters are selected randomly from a plurality of parameters representative of an interaction between a user of the mobile device and the one or more advertising content displayed on the mobile device. The one or more parameters may be in an encrypted form. The advertising system also includes a memory module to store the one or more parameters to keep track of the interaction and a processor to analyze the interaction.

Further, the processor is configured to detect a fraudulent activity by at least one of the user and the application, and generate a statistical report to facilitate decision making with respect to the one or more advertising content, the application, the developer and the mobile device.

Some embodiments of the invention provide a method for advertising on the mobile device. The method includes receiving advertisement configuration inputs corresponding to an application from an application developer. Thereafter, the method includes generating an advertising profile associated with the application and generating a software development kit (SDK). The SDK enables display of one or more advertising content on the mobile device via the application when the SDK is incorporated into the application and the application is installed on the mobile device. Subsequently, requests for supplying the one or more advertising content to the mobile device is received from the SDK of the installed application. Thereafter, the one or more advertising content are supplied to the mobile device based on the advertising profile associated with the application.

Following which, one or more parameters are received, in an encrypted form, from the mobile device. The one or more parameters are selected randomly from a plurality of parameters representative of an interaction between a user of the mobile device and the one or more advertising content displayed on the mobile device. The one or more parameters are then stored in a memory to keep track of the interaction.

Further, according to the method, the interaction are analyzed to detect any fraudulent activity of the user and the application, and to generate a statistical report to facilitate decision making with respect to the one or more advertising content, the application, the developer and the mobile device.

In some embodiments another method is provided for advertising on a mobile device when an application is running on the mobile device. The method includes a step of detecting an event during activity of the application on the mobile device and displaying one or more advertising content on at least a portion of a display screen of the mobile device on occurrence of the event based on an advertisement profile associated with the application.

Thereafter, the method includes sending one or more parameters, in an encrypted form, to an advertising system. The one or more parameters being selected randomly from a plurality of parameters representative of an interaction between a user of the mobile device and the one or more advertising content displayed. Further the one or more parameters enable the advertising system to track and analyze the interaction and thereby detect a fraudulent activity by either the user or the application. The one or more parameters also enable generations of a statistical report to facilitate decision making with respect to the one or more advertising content, the application, a developer of the application and the mobile device.

In another embodiment, the invention provides a computer program product that includes instruction for enabling the method of displaying advertising content on a mobile device.

In an embodiment, the ACD system may display an advertising content or an advertisement, such that the advertisement occupies the entire screen area of a mobile device. In another embodiment, the ACD system may display an advertisement occupying a portion of the screen of the mobile device. Hereinafter, the terms ‘advertising content’ or ‘advertisement’ may be interchangeably used, and it is to be understood that they refer to the same thing.

In an embodiment, when the ACD system displays the advertisement on a portion of the device screen, the portion of the screen displaying the advertisement may be specified by an application that is linked to the ACD system. The screen coordinates of the advertisement portion of the screen may be provided by the application linked to the ACD system via an application programming interfaces (API) call supplied by the ACD system.

In another embodiment, when the ACD system displays an advertisement that occupies the entire device screen area, the application linked to the ACD system may not be required to supply the advertisement display coordinates. In an embodiment, the ACD system may automatically determine the screen coordinates, by calling into an appropriate mobile device OS API that may return the size of the entire screen area of the device.

In an embodiment, the ACD system may display the full-screen advertisement in an event of beginning of the execution of the application that is linked to the ACD system, typically immediately before or immediately after the starting splash screen displayed by the application.

In another embodiment, the ACD system may display the full-screen advertisement in an event of ending of the execution of the application that is linked to the ACD system, typically after the very last screen of the application ceases to exist.

In yet another embodiment, the ACD system may display the full-screen advertisement at an opportune moment in the middle of the execution of the application linked to the ACD system, as may be suggested by the application itself via an API call supplied by the ACD system. For example, if the application is a game, then the full screen advertisement may be displayed in an event of transition between successive playing levels of such a game.

In an embodiment, start-up and termination of an application linked to the ACD system may be detected automatically by the ACD system. In another embodiment, events corresponding to start-up and termination of an application linked to the ACD system may be signalled to the ACD system by the application itself, via an API call supplied by the ACD system.

At least one other aspect of one or more embodiments of the present invention provides an advertising content request (ACR) system and associated methods. The ACR system may provide mechanisms for requesting advertisements on mobile devices from advertising servers.

In an embodiment, the ACR system may request an advertisement from an advertising server. In another embodiment, the ACR system may request an advertisement from a third-party advertising server.

In an embodiment, the ACR system may automatically form the advertisement request URL, without requiring any URL preparatory functions to be performed by an application linked to the ACR system.

In an embodiment, the ACR system sends an advertisement request URL to an advertising server, such that the application linked to the ACR system may not be required to perform sending the request by itself. In an embodiment, the ACR system may also process responses from the server to the advertising requests.

In an embodiment, the ACR system may deliver an advertisement from an advertising server to the ACD system. In an embodiment, the application linked to the ACR and ACD systems may not be required to perform any advertising-related function at all, as the display of the delivered advertisement may be completely performed by the ACD system.

At least one other aspect of one or more embodiments of the present invention provides an advertising server (AS) system and associated methods. The AS system may provide mechanisms for supporting the ACD and ACR systems.

In one embodiment, an advertisement-request receiving module of the AS system may receive a request for an advertisement from the ACR system and may reply to such a request with a response meaningful to and interpretable by the ACR system.

In an embodiment, an advertisement-supplying module of the AS system may deliver an appropriate advertisement to the ACR system.

In an embodiment, the AS system may provide auxiliary functions supporting completeness, integrity, or other useful and relevant features of the entire system.

In an embodiment, the AS system may perform an auxiliary function of registering events corresponding to the displaying of advertisements to users of the smartphone devices. In an embodiment, the AS system may perform an auxiliary function of registering events corresponding to clicks or other user actions solicited by the advertising display. Such an auxiliary function in these embodiments may be performed by an interaction-receiving module or an advertising interaction registration (AIR) system. Hereinafter, the terms ‘interaction-receiving module’ or ‘AIR system’ may be interchangeably used, and it is to be understood that they refer to the same thing.

In an embodiment, the AS system may perform another auxiliary function of verifying the advertising content display, click or any other kind of interaction between a user and the advertisement, or between a user and the ACD system, or between a user and the ACR system, had in fact taken place. Such a function may be performed by an advertising fraud detection (AFD) system or a processor present in the AS system. Hereinafter, the terms ‘processor’ or ‘AFD system’ may be interchangeably used, and it is to be understood that they refer to the same thing.

In an embodiment, the AS system may perform an auxiliary function of interacting between the ACD and/or ACR systems and application developers taking advantage of such a system. Such a function may be performed by a developer's portal (DP) system or a developer input module.

In an embodiment, the AS system may perform an auxiliary function of forwarding advertising content from third-party advertising servers. Such a function may be performed by an advertising forwarding (AF) system.

In an embodiment, when transferring data between the mobile terminal (device) and the ad server, the data is mixed in the exchange protocol according to the rules the mobile terminal (device) receives from the ad server.

In an embodiment, before sending the developer a link to the library for forwarding and displaying of advertising stored on the server, the library code may be encrypted or subjected to obfuscation to conceal its purpose or to prevent tampering and fraud, among other things.

In yet another embodiment, before sending the developer a link to the library for forwarding and displaying of advertising stored on the server, either the whole library code or some part of the library code may be translated into the code of a certain virtual machine.

In one such embodiment, the virtual machine may be a part of the library at the time the link is transferred for downloading by the developer.

In another such embodiment, the virtual machine may be downloaded from the server at the moment of library code execution on the mobile terminal.

In an embodiment, libraries for forwarding and displaying of advertising may be automatically created for the developer on the server.

In an embodiment, when exchanging information, special transformations of all transferred data may be applied (data mutation) to make exchange protocol unveiling more difficult.

In an embodiment, when exchanging information, either special transformations of some part of transferred data may be applied, or special transformations may not be applied at all.

In an embodiment, special transformations may be applied to the whole exchange protocol (that is, to service data and all other data), and in another embodiment the special transformations may not be applied to service data.

In one such embodiment, several transformation types may be successively applied to the data.

Any of the above embodiments may be used alone or together with one another in any combination. Inventions encompassed within this specification may also include embodiments that are only partially mentioned or alluded to or are not mentioned or alluded to at all in this brief summary or in the abstract.

As may be seen from the foregoing summary by a person skilled in the relevant art, the system and methods of the present invention provide an extremely easy to use, flexible and complete advertising system for developers of applications for mobile devices, thus allowing the developers to easily take advantage of the revenues coming from the many existing mobile advertising networks or other sources of advertising content.

The aspects, features, techniques and advantages of the present invention described herein are not all-inclusive, and, in particular, many additional aspects, features, techniques and advantages will be apparent to one of ordinary skill in the art in view of the figures and the following description of the preferred embodiments of the present invention.

The foregoing is the summary and thus contains, by necessity, simplifications, generalizations, and omissions of detail. Those skilled in the art will appreciate that the summary is illustrative only and is not intended to be in any way limiting.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 depicts a block diagram of an example of a system used for mobile advertising;

FIG. 2 is a block diagram of an embodiment of the structure of the SDK and the interaction between the developer application and the SDK;

FIG. 3 is a block diagram of an embodiment of the structure of the AD server and the interaction between the SDK and the AD server;

FIG. 4 illustrates an example of interaction between the AD server and the developer portal, interaction of the user and the administrator with the developer portal;

FIG. 5 is a flow chart of an embodiment of a method of interaction between the SDK and the AD server;

FIG. 6 is a flow chart of an embodiment of a method of interaction between the developer and the developer portal;

FIG. 7 illustrates an embodiment of the system database and modules that may interact with the system database;

FIG. 8 illustrates an example of method for building a web-application based on the SDK;

FIG. 9 illustrates an example of alternative way of web-application building based on the SDK;

FIG. 10 illustrates an embodiment of a method for personalization of advertising by means of the SDK;

FIG. 11 illustrates an embodiment of a method for applying exchange protocol mutations;

FIG. 12 demonstrates an example of system operations as a whole, from the SDK side;

FIG. 13 illustrates an example of data mutation when transferring data between the SDK and the AD server;

FIG. 14 is a block diagram of an embodiment of a system for mobile advertising.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Before describing the present invention in detail, it should be observed that the present invention utilizes a combination of method steps and apparatus components related to a method of advertising on a mobile device. Accordingly the apparatus components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

It will be appreciated that embodiments of the invention described herein may include one or more conventional processors and unique stored program instructions that control the one or more processors to implement, in conjunction with certain non-processor circuits, some, most, or all of the functions of method of advertising on a mobile device described herein. The non-processor circuits may include, but are not limited to, a radio receiver, a radio transmitter, signal drivers, clock circuits, power source circuits, and user input devices. As such, these functions may be interpreted as steps of a method to display advertisement on a mobile device. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention provides a system, a method and a computer program product that enables displaying advertising content on at least a portion of a display screen of a mobile device. Further, the system, the method and the computer program product of the invention provide a simplified way for application developers to integrate advertising in their applications.

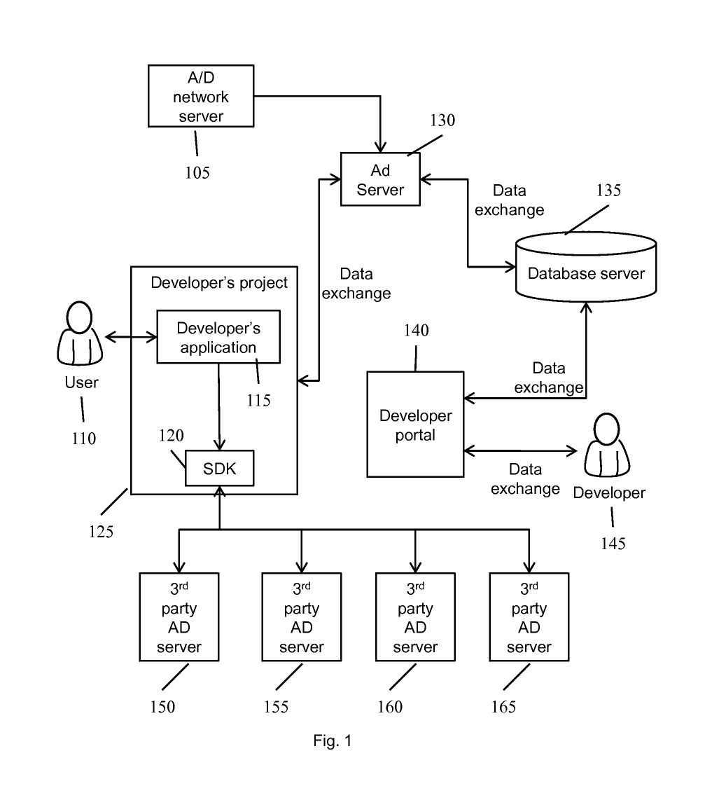

In general, at the beginning of the discussion of each of FIGS. 1-14 is a brief description of each element, which may have no more than the name of each of the elements in the one of FIGS. 1-14 that is being discussed. After the brief description of each element, each element is further discussed in numerical order. In general, each of FIGS. 1-14 is discussed in numerical order and the elements within FIGS. 1-14 are also usually discussed in numerical order to facilitate easily locating the discussion of a particular element. Nonetheless, there is no one location where all of the information of any element of FIGS. 1-14 is necessarily located. Unique information about any particular element or any other aspect of any of FIGS. 1-14 may be found in, or implied by, any part of the specification.

FIG. 1. depicts a block diagram of an example system used for mobile advertising. The developer portal (140) may allow application developers to create an account, register an application, and obtain a software development kit (SDK) for integrating ad sources into a new application, among other things. The application developer may also use the developer portal (140) to remove a previously registered application. In an embodiment, the system may also include a developer input module that is configured to receive advertisement configuration inputs from the application developer, wherein the advertisement configuration inputs correspond to an application. Further, based on these advertisement configuration inputs the system may generate an advertising profile associated with the application, using an advertising profile generation module. The advertising profile can include details relating to at least one of a unique identifier for the application, a duration of displaying the advertising content, choice of display type, a syntax string for requesting advertising content, a mobile communication device location, a mobile communication device OS, a mobile communication display screen size, hardware/software related parameters, and a parameter for checking type of the event.

The developer portal may provide features for ad display management. For example, an application developer may temporarily suspend ad displays for one or more of his/her applications through the use of the developer portal (140). Additionally, he/she may thereafter resume ad display through use of the developer portal (140). Further, the application developer may be able to edit keywords and categories of advertising content provided for display in each registered application.

The developer portal (140) may provide ad display statistics for each registered application. For instance, it may represent the total number of ad impressions in a given application and display frequency distribution in time. In another embodiment, the developer portal may provide the ratio of fraudulent ad display requests to the total number of ad impressions, or to the number of non-fraudulent ad display requests.

In an embodiment, the developer portal may enable the application developer to access his or her financial account associated with the mobile advertising system. The developer portal may provide an application developer with his or her current account balance. An application developer may also be able to request the funds be transferred to his/her account through a specified payment system. Furthermore, a developer may access the history of fund transfers from the account of the developer portal to the account of the payment system.

In an embodiment, an application developer may register an account on the developer portal (FIG. 1, 140) indicating an e-mail address and account ID of some payment system (for example, PayPal) for transferring payments received for displaying advertisements. Furthermore, an application developer might indicate personal information such as first name, last name, address, country, etc.

Upon account registration, an application developer may obtain a software development kit (SDK) for integrating advertising into applications. In order to obtain an SDK, the developer may need to register an application. For every registered application, a personalized SDK library may be created. It may not be necessary to register each application; it just makes it more convenient for an application developer to select the type of advertising for display and view impression statistics. In an embodiment, the SDK may be created by a software development kit (SDK) generation module of the system. The SDK enables display of one or more advertising content on the mobile device via the application, when the SDK has been incorporated into the application and the application is installed on the mobile device.

When registering each application, an application developer may indicate:

1. the platform which the application is developed for;

2. the application type;

3. the application name;

4. the advertising type, which may be selected from the set of provided categories of advertising content;

5. the keywords, which may be entered by the application developer to refine the selected categories of advertising content;

6. the advertising source, which may allow the developer to select a personal source of advertising content, or one of the portal-registered advertising aggregators, or a combination of the advertising sources.

At the final stage of application registration, the SDK for the application for the indicated platform may be assembled. The SDK may be created in the form of a library. The library may comprise the following integrated identifiers:

1. an account identifier for the application developer;

2. an identifier of the platform which the library was assembled for;

3. an application identifier.

The application developer may integrate the library into his/her application by inserting calls to the correspondent library functions in those places of the application source code where advertising may be displayed.

In an embodiment, the SDK can send advertisement display requests to the system, such that the request is received by the advertisement-request receiving module of the system. Thereafter, an advertisement-supplying module of the system can send the one or more advertising content to the mobile device based on the advertising profile associated with the application. In another embodiment, the advertisement display request can be sent to an ad server based upon the advertising profile corresponding to the application. The ad server (130) may service ad requests and process ad impressions reports. When an application calls the library function (SDK) to display advertising, the library may connect to the ad server. The library thereafter may send a special ad display request to the ad server. The ad display request may include the corresponding command (ad request), as well as information on the querying mobile device. The information in the display request may include, for example the following:

1. a model of the mobile device processor;

2. a model of the mobile device;

3. an IP address of the network adapter of the mobile device;

4. the battery charge level of the mobile device;

5. the RAM capacity of the mobile device;

6. the unique identifier of the mobile device.

The ad server may store the mobile device information in a database and, depending on the advertising profile of the application, respond with the following information:

1. an underlay—the underlay may be in the form of an image or other suitable format that does not contain any advertising information and may be used as a background to the ad. The underlay may contain a pre-marked area which when clicked, may minimize or close the advertisement. For instance, it may be an image including a window close button or other link. The library does not receive information on the coordinates of the pre-marked area, the area may be only known to the ad server to counteract check results substitution. The close button/pre-marked area may vary for different ad display requests;

2. if the advertising profile of the application includes a custom ad content source, the ad server may send such an advertisement which may be in the form of text, image, animation, etc.;

3. if the advertising profile of the application includes one of the advertising aggregators, the ad server may send a link (URL) which may enable the library to download an advertisement from the ad server of the chosen aggregator. In another embodiment, the ad server may send several links to ad servers of various aggregators, and the library may choose from one of the links to download an advertisement. If there is no connection to the ad server of the chosen aggregator, the library may attempt to download the advertisement using one of the other received links. In yet another embodiment, preset links to servers of advertising aggregators may be integrated into the library. In an embodiment, instead of links, the ad server may send the identifiers of advertising aggregators which the library may call to download an advertisement.

Along with an advertisement, a hyperlink may be sent which may open in a web-browser window of the mobile device in the event the user clicks the advertisement area.

In an embodiment, the library may place the advertisement onto the underlay, thereby creating the whole advertising image. The combined image may then be displayed on the screen of a mobile device.

During the advertising image display, in an embodiment, the library may track the clicks the user of a mobile device makes on the advertising image. Coordinates of each click may be sent to the ad server. The ad server may respond with a command. If the user of a mobile device clicks the advertisement area, and there was a hyperlink sent along with the advertisement, the hyperlink that was sent may open in the web-browser of the mobile device. If the user of the mobile device clicks the close area, the ad server, upon receiving click coordinates, identifies that the coordinates fall into the close area and sends the command to the library to terminate advertisement display. The library receives this command and closes the advertisement. If the user of the mobile device clicks some other part of the adverting image (except for the advertisement area and the close area), the ad server may save the information associated with the click but may not send any commands to the mobile device.

In another embodiment, an interaction-receiving module of the system can receive one or more parameters representative of an interaction between a user of the mobile device and the one or more advertising content. The one or more are selected randomly from a plurality of parameters related to the interaction and the mobile device. Further, in embodiments, the one or more parameters are received in an encrypted form. Thereafter, the one or more parameters may be stored in a memory module to keep track of the interaction and a processor may analyze the interaction to either detect a fraudulent activity of the user or the application. Further the processor may also be configured to generate a statistical report based on the one or more parameters, the report assisting in a financial decision making in relation to the one or more advertising content, the application and the developer.

Examples of parameters representative of the interaction between the user of the mobile device and the one or more advertising content include, but are not limited to, a mobile communication device identifier, a mobile communication device location, a mobile service provider, an internet provider, and a response of the user to the one or more advertising content.

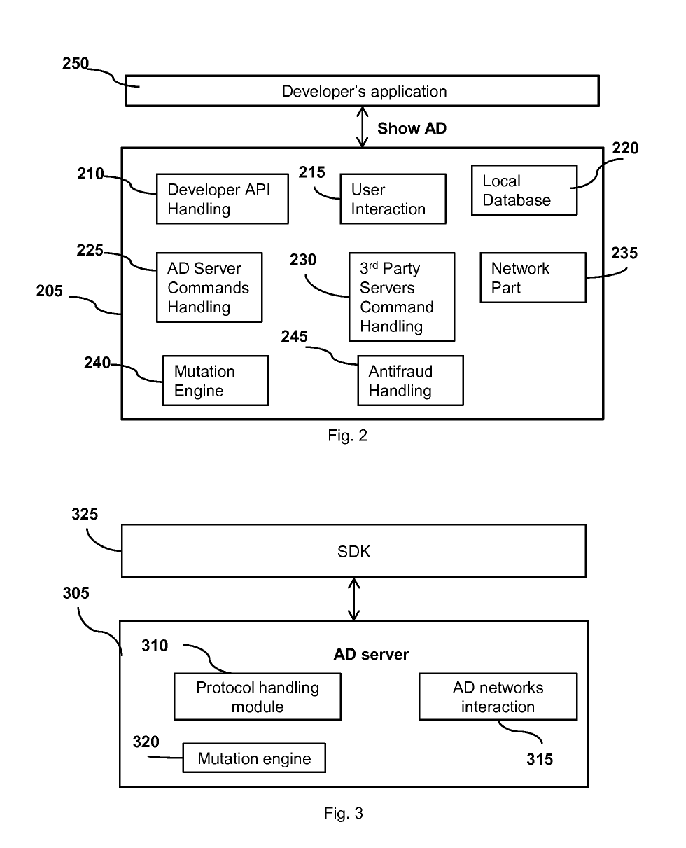

FIG. 2 illustrates interaction between developer application 250 and SDK 205. The developer may need to perform certain basic steps for the developer application to be able to display advertising. The developer might:

1. download SDK 205 from the developer portal;

2. integrate SDK 205 into the developer application project;

3. integrate a call to the method for ad display into developer's application 250.

FIG. 2 also illustrates the structure of SDK 205:

1. Developer API handling 210 implements the interface for interaction with the developer application. The interface may be implemented by a set of methods (functions) for initiating the display of an advertisement in the developer application, and the interface may be characterized by one or more methods (functions) that may be desirable for the operation under the conditions and platform chosen by the developer.

2. User interaction 215 performs the functions necessary for interaction with the user who uses the developer application with an integrated SDK. The list of functions of module 215 may include:

2.1. Image display on the screen;

2.2. Retrieval of user input;

2.3. Changing the parameters of displayed advertising;

2.4. Other functions necessary for interaction with the user and expanding the capabilities of the interaction.

3. Local database 220 may be used to store temporary and permanent data that may be desirable (and/or necessary) for SDK operation in the user device. The database may be stored in the user device and available without a network connection. The data may include:

3.1. Advertising settings;

3.2. Logs.

4. The purpose of AD server command handling 225 may be to properly form and initiate commands sent to the AD server, as well as to process responses from the AD server. The supported commands may include:

4.1. Connection management commands (session opening and closing);

4.2. Advertising retrieval commands;

4.3. Commands for registration of reports on ad impressions and clicks.

5. 3rd-party servers command handling 230 may be responsible for proper interaction with third-party ad servers. The system may combine, select, request, send, as well as perform other actions with advertising, both automatically and under the control of the user. Advertising may be located not only on own server 130, but also on other servers and in other advertising networks (105, 150, 155, 160, 165) that implement various protocols of interaction with resources therein, which may require proper interaction with servers and advertising networks. Module 230 may include the following functions:

5.1. Creating a link based on the protocol of the accessed ad server;

5.2. Downloading advertising from the ad server.

6. Mutation engine 240 may be used to convert (obfuscate) the protocol of SDK and AD server exchange. Module 240 may provide better protection from possible fraud and reveal the protocol's underlying structure. Module 240 may include the implementation of algorithms that define the conversion of the exchange protocol into a form making it impossible or difficult to restore the initial exchange protocol between SDK 205 and AD server 130.

7. Antifraud handling 245 may prevent or reduce the number of fraudulent ad impressions and/or click-throughs by filtering fraudulent user actions by means of a processor that includes specialized programs, or software systems, or software-and-hardware systems. Module 245 may include such functions as:

7.1. Adding captcha (the element which allows distinguishing a user from a user emulator) to the advertising image or text;

7.2. Retrieving processor frequency, measuring the speed of execution of specified program sections, and then comparing current parameters to expected ones.

FIG. 3 illustrates interaction between SDK 205 and AD server 305. The purpose of the AD server is to process requests from the SDK, the SDK requests may represent:

1. Requests for session management;

2. Ad retrieval requests;

3. Requests for ad impressions and clicks registration.

AD server 305 may include:

1. Protocol handling module 310, which may receive commands for SDK 325 and may preprocess the commands. The commands for SDK 325 may represent:

1.1. Commands to open and close a session;

1.2. Commands to send an ad impression report.

2. AD networks interaction module 315 may standardize the protocol of exchange with various advertising networks and ad servers. Module 315 may include methods for the following:

2.1. Advertising retrieval;

2.2. Sending reports on ad impressions or click-throughs.

Standardizing the protocol of exchange unifies the methods of calling advertising networks and ad servers with different interaction protocols.

3. The purpose of mutation engine 320 may be similar to that of module 205, but in module 305 may perform additional functions. The list of additional functions may include:

3.1. Interaction with developer portal 405 to retrieve the description of new mutation algorithms;

3.2. Support for logical connections between mutation engine 320 and mutation engine 240.

These techniques (3.1 and 3.2) may allow maintaining the necessary number of both mutation algorithms at any moment, and logical connections with corresponding algorithms on mobile devices.

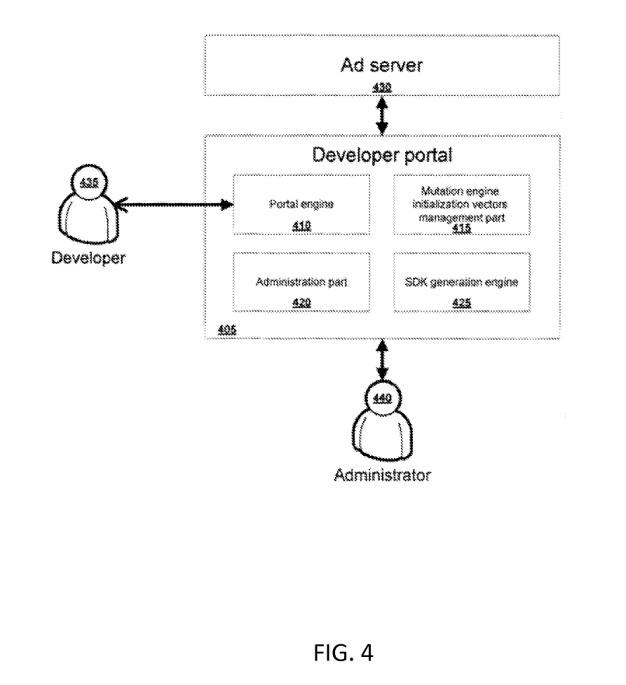

FIG. 4 illustrates interaction between the AD server 430 and the developer portal 405 and its subsystems, interaction of the user 435 and the administrator 440 with the developer portal 405 and the subsystems of the developer portal 405. The developer portal may perform functions for operation of the whole system. These functions may include:

1. Registration of users;

2. Registration of applications;

3. Management of personal user information (for example, contact information, billing details);

4. Selecting options of advertising to be displayed on devices;

5. Display of statistics on ad impressions and click-throughs;

6. SDK generation for various platforms and application types;

7. Providing communication between the developer and the administrator.

The developer portal may include the following components:

1. Portal engine 410, which may be the core of the system that manages data stored in database 705. Functions of portal engine 410 may include the support of data integrity and relevance, as well as interaction with developer 435. In one embodiment, interaction with the developer may be carried out through a web interface. By means of the interface provided by portal engine 410, developer 435, for instance, may perform the following actions:

1.1. Register at the developer portal;

1.2. Register and remove his/her applications at the developer portal;

1.3. Edit personal information (for instance, contact information, billing and payment details, etc.);

1.4. Download the SDK from the developer portal;

1.5. View ad impressions and click statistics for his/her applications;

1.6. Manage ad impressions in his/her applications (for example, change keywords used for advertising selection, or disable ad impression in his/her application);

1.7. Add his/her own advertising;

1.8. Start his/her ad campaign or join an existing ad campaign;

1.9. Withdraw accrued funds from the system;

1.10. Add funds to the personal account in the system to pay for paid services (for instance, start of a personal advertising campaign).

2. Mutation engine initialization vectors management part 415 may provide an interface for adding, deleting, editing and performing other operations on parameters of the antifraud system that contributes to protocol mutation to counteract the examination of the underlying structure of the system. This part of the developer portal (the mutation engine initialization vectors management part 415) may not be available to users and developers.

3. Administration part 420 may be intended for administrator 440 and may allow him/her to perform the following functions, for example:

3.1. Manage the developer's account availability;

3.2. Manage advertising availability for the developer's applications;

3.3. Manage reports;

3.4. Optimize the portal for search engines.

4. SDK generation engine 425 may be used to generate one or more SDK(s) for one or more platforms that were preset by developer 435. For instance, if the developer is creating the application for use on mobile device OS platforms Symbian, iPhone, and Android, after SDK generation he/she may be offered to download SDKs for all these platforms with built-in data required for ad display in the developer applications.

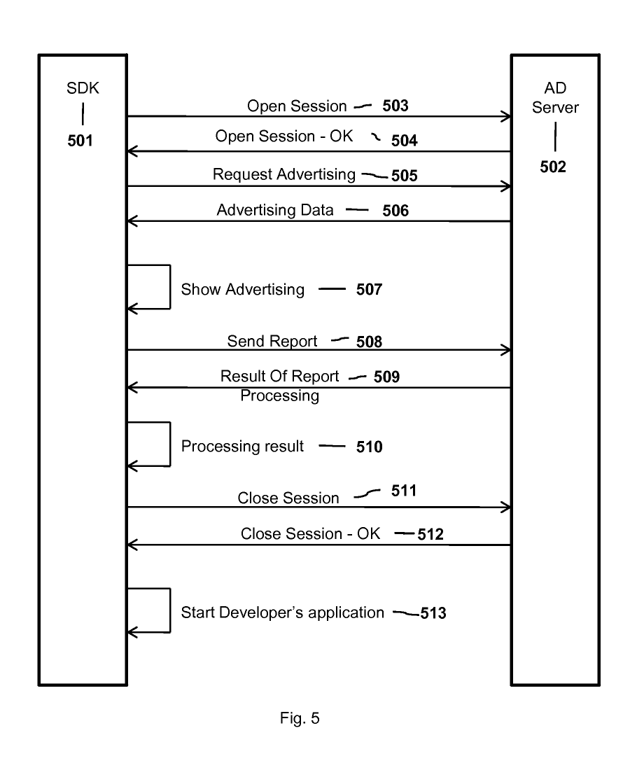

FIG. 5 is an example of a flowchart of interaction between the SDK and the AD server. FIG. 5 illustrates one of the possible embodiments of SDK 501 and AD server exchange protocol.

Upon developer application start, a function from SDK 501 may be called. In step 503, the function 501 may attempt to open a session with AD server 502. If the session between SDK 501 and the AD server 502 is successfully opened, an encrypted channel may be opened, which may be used by the SDK 501 and the AD server 502 until the session is closed.

After open session command is processed in step 503, in step 504, AD server 502 may send to SDK 501 a message confirming successfully opening a session, as well as other additional data. Additional data may, for example, include initialization data for Mutation engine 240.

In step 505, the SDK may send a request to retrieve advertising from the AD server. Also, additional data comprising, for instance, device information may be sent to the AD server.

The additional data may be stored on the server.

In step 506, the AD server may send data to the SDK; after processing the data, the SDK receives advertising content. The AD server may send either ad content itself (for example, in the form of text or an image), or a link (for instance, URL) to retrieve advertising content. Advertising content may be received either from the AD server itself or from third-party ad servers and/or ad networks.

In step 507, the SDK may display advertising to the application user and processes user actions (for instance, retrieves click coordinates when the user clicks on the screen).

In step 508, the SDK sends a report on ad display and user actions (for instance, coordinates of screen clicks) to the AD server.

In step 509, the AD server may send data including the result of processing request 508. The result may indicate further actions to the SDK (for example, close the advertisement or follow the ad link), the result may also include additional data (such as a new link to be followed).

In step 510, the SDK may process data received in step 509 and perform actions based on the received data (for example, closes the advertisement).

In step 511, the SDK may request the AD server to close the session.

In step 512, the AD server may notify the SDK of the result of the session and close request.

In step 513, the SDK terminates.

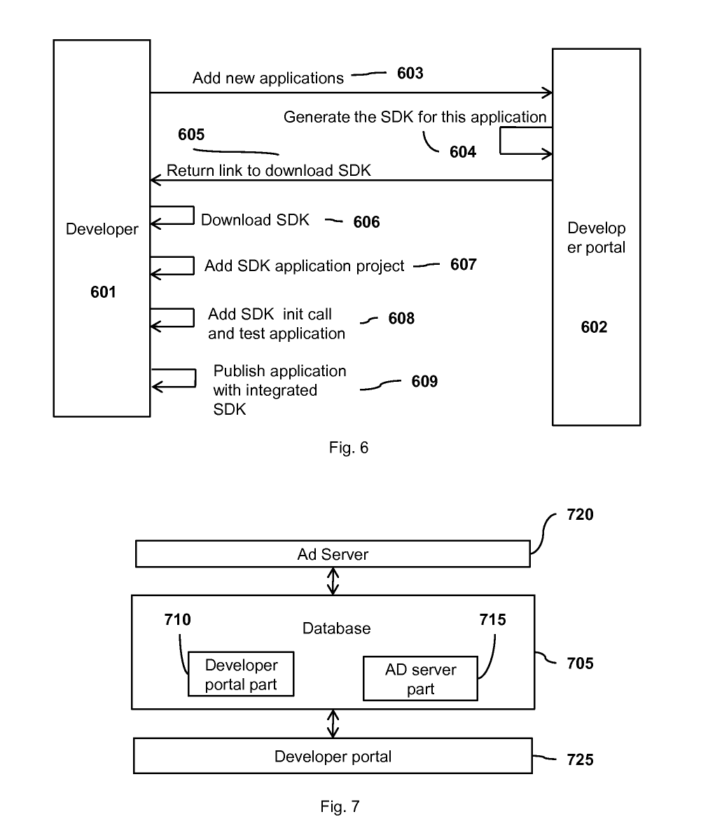

FIG. 6 illustrates one of the possible scenarios of interaction between developer 601 and developer portal 602, in particular integration of the application and the SDK.

In order to integrate the developer application with the SDK, the following steps may be taken:

1. In step 603, the developer may add the new application to the developer portal. The developer 601 may provide the data necessary for the addition of the new application (for instance, through the web interface); the data may, for example, include: the application name, a link to the application website, one or more platforms under which the application is supposed to run, an application type (for example, web application, native application, or any other valid application type), a brief description, a selection of enabled ad categories, and/or keywords for triggering the display of the ad.

2. In step 604, the developer portal generates the SDKs for all platforms indicated by the developer. An SDK with built-in user parameters for all platforms and application types may be generated (for example, applications for Symbian and Android are generated, and for each of these platforms there are two application types: a web application and a native application; developer parameters such as, for example, developer identifier and application identifier, are added to each SDK).

3. In step 605, the developer portal may return a link for downloading the generated SDK(s).

4. In step 606, the developer may download the generated SDKs from the developer portal.

5. In step 607, the developer may add the SDK to the developer application project. For different platforms and integrated development environments (IDE), the addition may be carried out based on the IDE requirements.

6. In step 608, the developer may add an SDK initialization call and test application. Adding the SDK initialization call and test application may be carried out manually by editing the source code, or by means of IDE, or automatically using integration utilities, or by any other means aimed at achieving a similar result, both on the developer computer(s), or on a third-party computer(s), and right on the developer portal both by the developer and by any other person, or completely automatically without human assistance.

7. In step 609, the developer may publish the application by assembling (e.g., compiling) the application. At this stage, the developer gets the application with an integrated SDK.

While generating the SDK, the SDK may be obfuscated, both at the level of source code and at the level of intermediate or binary (machine) code, as well as at any other level.

FIG. 7 illustrates system database 705 and modules interacting with database 705.

The database may include the following components:

1. Developer portal part 710;

2. AD server part 715.

The developer portal part 710 may store the data for operation of the developer portal (for instance, developers data, applications data, data on number of applications and relations between developers and applications, data on ad servers and ad networks, etc.).

The AD server part 715 may store the AD server specific data (for example, opened sessions, ad reports, etc.).

All database components may be either logically connected or independent, and located either on one and the same server or on multiple ones.

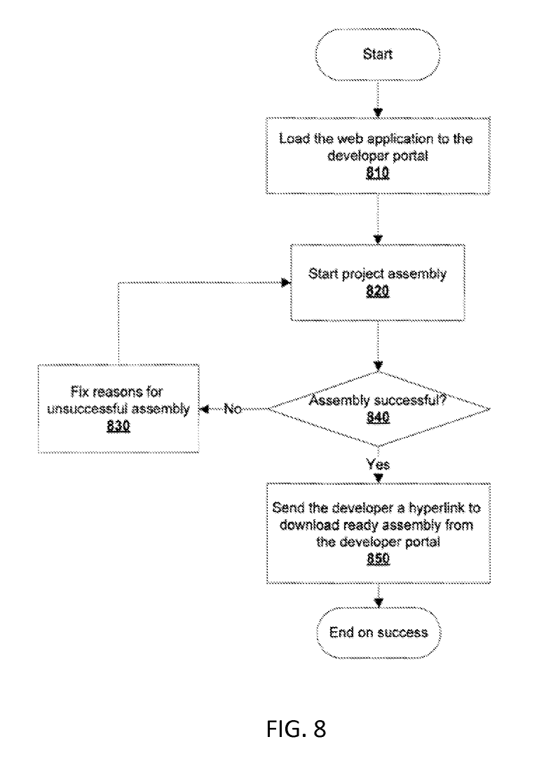

FIG. 8 illustrates an example of a method of application integration; in the method, a portion of the integration may be implemented as a web application, and another portion as a native application with an SDK for the corresponding platform. The method may also be applied for the generation of other application types (for example, fully web-based applications).

In step 810, the developer application to be integrated with the SDK may be uploaded to the developer portal, where it may be converted into the desired format.

In step 820, SDK generation may be launched, and upon generation of the necessary SDK(s), the application uploaded at stage 810 may be integrated with the corresponding SDK.

In step 840, integration may be validated and the process moves to step 850.

If an error occurs in step 840, an attempt to eliminate the error may be made in step 830. Errors may be eliminated both manually and automatically, and both locally and remotely.

In step 850, the developer may be provided with a link or links to download the applications with the integrated SDK.

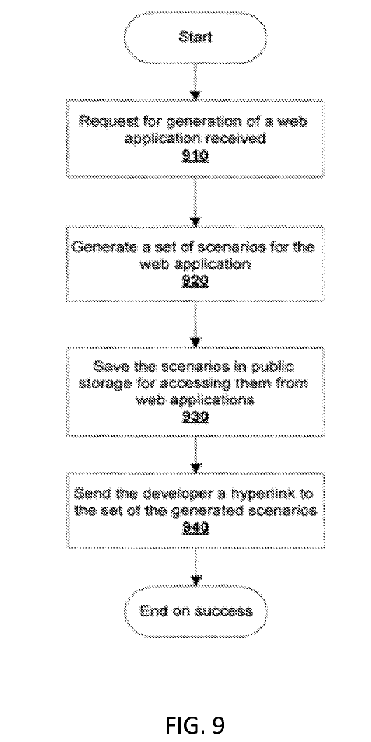

FIG. 9 illustrates an example of another method of application integration; in this method, one portion may be implemented as a web application, and the other portion as a native application with an SDK for the corresponding platform. This possible method may also be applied for the generation of other application types (for example, fully web-based applications).

In step 910, a request may be sent for the generation of one or more SDKs for the chosen platforms with integrated user and application parameters and received by the developer portal.

In step 920, one or more SDKs for the chosen platforms with integrated user and application parameters may be generated.

In step 930, the generated SDKs may be placed using links preset by the developer or obtained in some other way. The links themselves may be placed into the SDK in step 920. Later, the developer application may obtain a library for displaying ads through the network using the preset links or links obtained in some other way.

In step 940, the developer may be provided with a link or links to download the generated SDK.

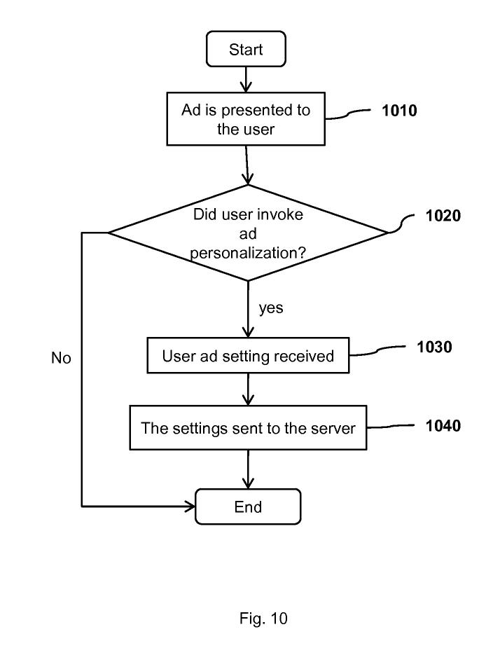

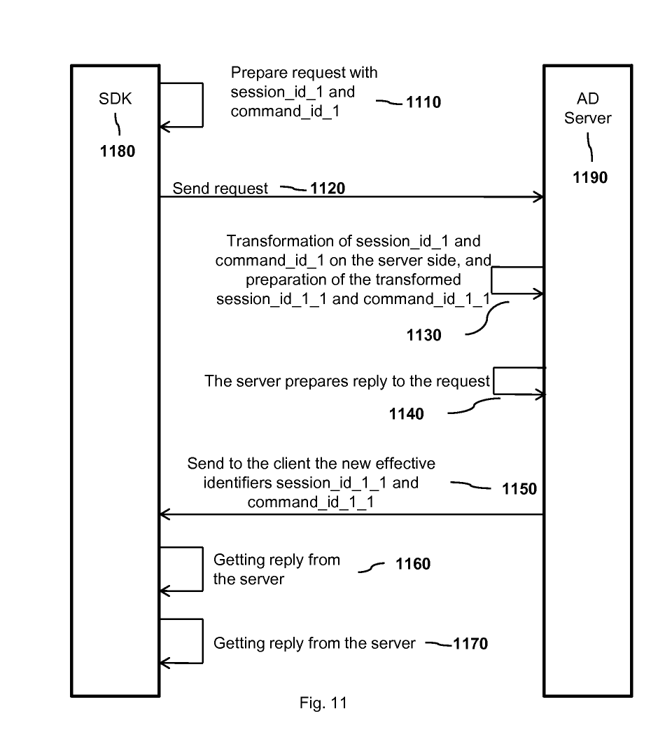

FIG. 10 illustrates how a user may influence the subject and other possible parameters of displayed advertising; when changed by the user, data may be sent to the developer and application support server. Afterwards, for this application instance, advertising may be selected based on the additional data.

FIG. 11 illustrates an example of a method for protocol mutations during data exchange between SDK 1180 and AD server 1190. To hide the constancy of session and command identifiers, the server, upon receiving and executing the command, may convert session_id and command_id according to some algorithm (MD5, SHA, RIPEMD, etc.) and send the session_id and command_id, in response to a mobile terminal; the mobile terminal, upon the next request, may send the server the converted session_id. The session identifier may change for each request. The converted command may be cashed, and upon the next request with this command identifier, the converted command is chosen. To make analysis difficult, the request processing server may randomly apply multiple hashing algorithms, including algorithms of the request processing server, instead of just applying one algorithm. Applying multiple hashing algorithms may ensure identifiers for each request are completely different from previous identifiers, which may allow the hiding of exchange protocol details and may make a fraudster investigate the encrypted and obfuscated code (to thereby deter the fraudster).

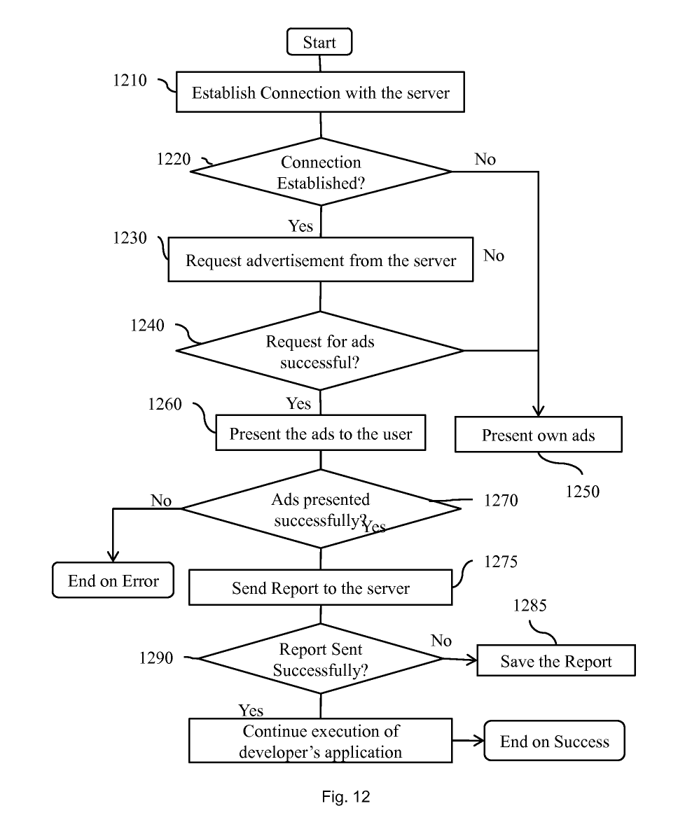

FIG. 12 illustrates an example of a method of system operation.

In step 1210, a connection to the server may be established and the exchange of additional information for proper operation may take place.

In step 1220, it is verified whether connection to the server was successful; otherwise, the process passes to step 1250. If connection is successful, the process passes to step 1230.

In step 1230, advertisements may be downloaded from the server to the mobile device. Also, this stage may include: data preparation for requesting the ad, advertisement downloading from the server, additional manipulations with the advertisement before the advertisement is displayed to the user.

In step 1240, verification of whether the advertisement was successfully downloaded may occur; otherwise, the process passes to step 1250.

In step 1260, the advertisement may be displayed to the user. At this stage, additional user interactions may be performed (for example, interaction by means of the touch screen, captcha display, etc.).

In step 1270, it may be verified whether the advertisement was successfully displayed to the user; and if the step 1270 fails, the ad display system terminates on the mobile device.

In step 1275, a report may be transferred to the ad server. Along with the report, additional parameters may be transferred (for instance, coordinates of clicks on the touch screen).

In step 1280, verification whether the report was successfully sent to the server may be determined; if the sending failed, the process passes to step 1285.

In step 1285, the report may be saved on the mobile device and may later be sent to the server (for instance, in step 1210).

In step 1290, the connection to the advertising server may be closed, and execution of the application with the integrated SDK may begin.

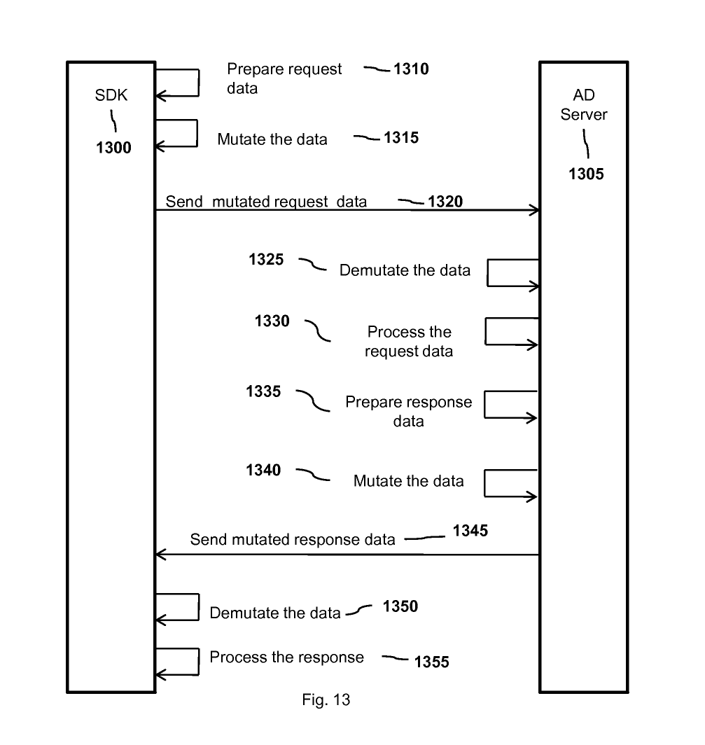

FIG. 13 illustrates a method for mutation of transferred data. In FIG. 13, mutations are applied to data transferred within data packets. The exchange may involve SDK 1300 and AD server 1305. Protocol mutation may be applied irrespective of whether the environment of transmission from the SDK to the AD server is protected or not.

In step 1310, the SDK prepares data for mutation. Preparation may include placing of source data into a container (for example, a byte array) which may be subjected to mutation transformations.

In step 1315, the data may be subjected to mutation (specific transformation, either taking into account the type of mutated data and the format of the packet or container or not).

In step 1320, the mutated data may be transferred to AD server 1305.

In step 1325 the data from the SDK may be subjected to reverse transformation (demutation) to retrieve source data.

In step 1330, the restored data may be processed by the server.

In step 1335, the AD server may prepare data for mutation. Preparation may include placing of source data into a container (for example, a byte array) which may be subjected to mutation transformations.

In step 1340, the data may be subjected to mutation (specific transformation, either taking into account the type of mutated data and the format of the data packet or container or not).

In step 1345, the data may be sent to the SDK.

In step 1350, the data from the AD server may be subjected to reverse transformation (demutation) to retrieve source data.

In step 1355, the restored data may be processed by the SDK.

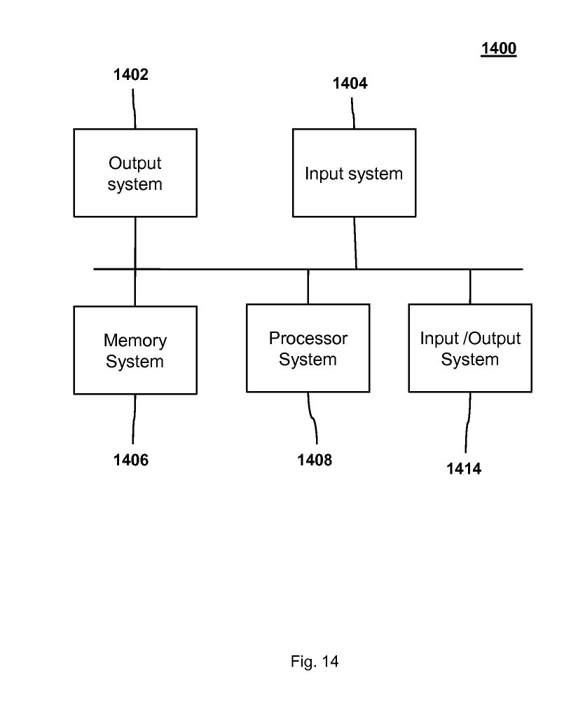

FIG. 14 is a block diagram of an embodiment of a system for mobile advertising. The device may include output system 1402, input system 1404, memory system 1406, processor system 1408, communications system 1412, and input/output device 1414. In other embodiments, the system 1400 may include additional components and/or may not include all of the components listed above.

Device 1400 is an example of a system that may be used for the method for advertising on mobile devices. System 1400 may be a mobile device, a computer system, a server system, or a database system, among other things.

Output system 1402 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Output system 1402 may include any type of advertisement, including visual and audio output. Output system 1402 may include lights, such as a red light and/or a flashing light. Output system may include sounds such as beeps, rings, buzzes, sirens, a voice message, and/or other noises. Output system may include electronic ads sent via network or wireless. Output system may include ads sent via a local area network, wide area network, or wireless network. Output system may include ads sent via an internal video, close circuit TV or TV. Output system may include audio ads sent via a phone, pager, fax, mobile phone network, or ordinary phone network. Output system may include recording a log and report internally in a database or event log. Output system may include mobile SMS or MMS or pager sent to users. Output system 1402 may send an e-mail, make a phone call, and/or send other forms of ads to users. Output system 1402 may be part of the ad server or may be separate. Output system 1402 may include a communication system that includes an antenna system for sending and receiving data.

Input system 1404 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 1404 allows the ad server administrator to interact with the system for advertising on mobile devices. Input system 1404 allows application developers to create an account on the dedicated server and register their applications thereon. Application developers can also enter information for transferring payments for ad display. The details of applications ad subscription can be downloaded from the dedicated server to a computing device through a communication channel. These details can include, but are not limited to: application identification, application developer's account identification for ad display registration, as well as parameters of the ad display mechanism. Input system 1404 may include a communication system including an antenna system for sending and receiving data. Input system 1404 may include a camera system for capturing images.

Memory system 1406 may include, for example, any one of, some of, any combination of, or all of a long term storage system, such as a hard drive; a short term storage system, such as random access memory; a removable storage system, such as a floppy drive or a removable drive; and/or flash memory. Memory system 1406 may include one or more machine-readable mediums that may store a variety of different types of information. The term machine-readable medium is used to refer to any medium capable carrying information that is readable by a machine. One example of a machine-readable medium is a computer-readable medium. Memory system 1406 allows the system to remember/store, for example, information including but not limited to: a list of applications, algorithms, previous events, registered applications, which ads go with which applications, fees for advertising, number of ads send to customers, customer's reaction to ads, and advertisements. The Memory system 1406 may be a part of the ad server or may be separate.

Processor system 1408 may include any one of, some of, any combination of, or all of multiple parallel processors, a single processor, a system of processors having one or more central processors and/or one or more specialized processors dedicated to specific tasks. Processor system 1408 may include any one of, some of, any combination of, or all of multiple parallel processors, a single processor, a system of processors having one or more central processors and/or one or more specialized processors dedicated to specific tasks. Optionally processor system 1408 may include a neural network. Optionally, processor system 1408 may be configured as a vector machine (e.g., which handles multiple repetitive steps as one parallel computation) and/or may include a massively-parallel processing system (in contrast to a vector machine, a non vector machine may ordinarily perform the same computation using a loop that repeats the same or a similar calculation each time the loop repeats another cycle). Processor system 1408 may run a program stored on memory system 1406 for identifying an application from a list of applications, analyzing/detecting events from one or more user computers and decides whether to send an ad and/or which ad to send. Processor system 1408 may implement the algorithm of ad display identifying the need for an ad display 1400. Processor system 1408 can keep track of user actions with respect to ads.

Communications system 1412 communicatively links output system 1402, input system 1404, memory system 1406, processor system 1408, and/or input/output system 1414 to each other. Communications system 1412 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 1410 may include devices that have the dual function as input and output devices. For example, input/output system 1410 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1410 is optional, and may be used in addition to or in place of output system 1402 and/or input device 1404. Input/output system 1410 can be used by developers, customers (users) and/or system administrators.

In an embodiment, the invention also includes one or more machine-readable mediums in form of a computer program product that may store a variety of different types of information. The term machine-readable medium is used to refer to any medium capable of carrying information that is readable by a machine. One example of a machine-readable medium is a computer-readable medium. The computer program product can carry instructions for carrying out the method of displaying advertising content on a mobile device as described above.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

What is claimed is:

1. An advertising system for advertising on a mobile communication device, the advertising system comprising:
a developer input module, said developer input module configured to receive advertisement configuration inputs corresponding to an application from an application developer;
an advertising profile generation module, said advertising profile generation module configured to generate an advertising profile associated with said application;
a software development kit (SDK) generation module, said SDK generation module configured to generate an SDK, wherein said SDK enables display of one or more advertising content on said mobile communication device via said application when said SDK is incorporated into said application and said application is installed on said mobile communication device;
an advertisement-request receiving module, wherein said advertisement-request receiving module configured to receive requests for supplying said one or more advertising content to said mobile communication device, said requests being received from said SDK of said installed application on occurrence of an event during activity of said installed application;
an advertisement-supplying module, said advertisement-supplying module configured to send said one or more advertising content to said mobile communication device based on said advertising profile associated with said application;
an interaction-receiving module, said interaction-receiving module configured to receive one or more parameters selected randomly from a plurality of parameters representative of an interaction between a user of said mobile communication device and said one or more advertising content being displayed on said mobile communication device, wherein said one or more parameters are received in an encrypted form;
a memory module, said memory module configured to store said one or more parameters to keep track of said interaction; and
a processor, said processor configured to analyze said interaction to at least one of:
detect a fraudulent activity by at least one of said user and said application; and
generate a statistical report to facilitate decision making regarding at least one of said one or more advertising content, said application, said developer and said mobile communication device.

2. The advertising system of claim 1, wherein said one or more advertising content occupy an entire screen area of a display screen of said mobile communication device.

3. The system of claim 1, wherein a size of portion of a display screen of said mobile communication device occupied by said one or more advertising content is specified in said advertising profile.

4. The advertising system of claim 1, wherein said advertising profile includes at least one of a unique identifier for said application, a duration of displaying said advertising content, a choice of display type, a syntax string for requesting advertising content, a mobile communication device location, a mobile communication device OS, a mobile communication display screen size, hardware/software related parameters, and a parameter for checking type of said event.

5. The advertising system of claim 1, wherein said advertising profile can be specific to said user.

6. The advertising system of claim 1 further comprising retrieving said one or more advertising content from a server based on said advertising profile associated with said application.

7. The advertising system of claim 1, wherein said event during activity of said application is one of a start of said application, an end of said application, before a splash screen display, after a splash screen display, a transition from said application to another application, and a transition back from another application to said application.

8. The advertising system of claim 1, wherein said plurality of parameters representative of said interaction between said user of said mobile communication device and said one or more advertising content being displayed on said mobile communication device include at least one of a mobile communication device identifier, a mobile communication device location, a mobile service provider, an internet provider, and a response of said user to said one or more advertising content.

9. A method for advertising on a mobile communication device, the method comprising:
receiving advertisement configuration inputs corresponding to an application from an application developer;
generating an advertising profile associated with said application;
generating a software development kit, wherein said SDK enables display of one or more advertising content on said mobile communication device via said application when said SDK is incorporated into said application and said application is installed on said mobile communication device;
receiving requests for supplying said one or more advertising content to said mobile communication device, said requests being received from said SDK of said installed application;
supplying said one or more advertising content to said mobile communication device based on said advertising profile associated with said application;
receiving one or more parameters selected randomly from a plurality of parameters representative of an interaction between a user of said mobile communication device and said one or more advertising content being displayed on said mobile communication device, wherein said one or more parameters are received in an encrypted form;
storing said one or more parameters in a memory to keep track of said interaction; and
analyzing said interaction to at least one of:
detect a fraudulent activity by at least one of said user and said application; and
generate a statistical report to facilitate decision making regarding at least one of said one or more advertising content, said application, said developer and said mobile communication device.

10. The method of claim 9, wherein said one or more advertising content occupy an entire screen area of a display screen of said mobile communication device.

11. The method of claim 9, wherein a size of portion of a display screen of said mobile communication device occupied by said one or more advertising content is specified in said advertising profile.

12. The method of claim 9, wherein said advertising profile includes at least one of a unique identifier for said application, a duration of displaying said advertising content, a choice of display type, a syntax string for requesting advertising content, a mobile communication device location, a mobile communication device OS, a mobile communication display screen size, hardware/software related parameters, and a parameter for checking type of said event.

13. The method of claim 9, wherein said advertising profile can be specific to said user.

14. The method of claim 9 further comprising retrieving said one or more advertising content from a server based on said advertising profile associated with said application.

15. The method of claim 9, wherein said event during activity of said application is one of a start of said application, an end of said application, before a splash screen display, after a splash screen display, a transition from said application to another application, and a transition back from another application to said application.

16. The method of claim 9, wherein said plurality of parameters representative of said interaction between said user of said mobile communication device and said one or more advertising content being displayed on said mobile communication device include at least one of a mobile communication device identifier, a mobile communication device location, a mobile service provider, an internet provider, and a response of said user to said one or more advertising content.

17. A method for advertising on a mobile communication device when an application is running on said mobile communication device, the method comprising:
detecting an event during activity of said application on said mobile communication device;
displaying one or more advertising content on at least a portion of a display screen of said mobile communication device on occurrence of said event based on an advertisement profile associated with said application; and
sending one or more parameters to an advertising system, said one or more parameters being selected randomly from a plurality of parameters representative of an interaction between a user of said mobile communication device and said one or more advertising content, wherein said one or more parameters are sent in an encrypted form, and further wherein said one or more parameters facilitate said advertising system to track and analyze said interaction to at least one of:
detect a fraudulent activity by at least one of said user and said application; and
generate a statistical report to facilitate decision making regarding at least one of said one or more advertising content, said application, a developer of said application and said mobile communication device.

18. The method of claim 17, wherein said one or more advertising content occupies an entire screen area of said display screen.

19. The method of claim 17, wherein a size of portion of a display screen of said mobile communication device occupied by said one or more advertising content is specified in said advertising profile.

20. The method of claim 17, wherein said event during activity of said application is one of a start of said application, an end of said application, before a splash screen display, after a splash screen display, a transition from said application to another application, and a transition back from another application to said application.

21. The method of claim 17 further comprising retrieving said one or more advertising content from an advertisement system.

22. The method of claim 17 further comprising retrieving said advertising profile from an advertisement system.

23. The method of claim 17, wherein said detecting comprises receiving a notification from said application on occurrence of said event.

24. The method of claim 17, wherein said detecting comprises at least one or periodically and continually monitoring a status of said activity of said application.

25. The method of claim 17, wherein said advertising profile includes at least one of a unique identifier for said application, a duration of displaying said advertising content, a choice of display type, a syntax string for requesting advertising content, a mobile communication device location, a mobile communication device OS, a mobile communication display screen size, hardware/software related parameters, and a parameter for checking type of said event.

26. The method of claim 17, wherein said advertising profile can be specific to said user.

27. The method of claim 17, wherein said plurality of parameters representative of said interaction between said user of said mobile communication device and said one or more advertising content being displayed on said mobile communication device include at least one of a mobile communication device identifier, a mobile communication device location, a mobile service provider, an internet provider, and a response of said user to said one or more advertising content.

28. A computer program product for use in a computing device, said computing device being configured for advertising on a mobile communication device when an application is running on said mobile communication device, said computer program product comprising at least one computer-readable storage medium having computer-readable program code portions stored therein, said computer-readable program code portions comprising instructions for:
detecting an event during activity of said application on said mobile communication device;
displaying one or more advertising content on at least a portion of a display screen of said mobile communication device on occurrence of said event based on a configuration data corresponding to said application; and
sending one or more parameters to an advertising system, said one or more parameters being selected randomly from a plurality of parameters representative of an interaction between a user of said mobile communication device and said one or more advertising content, wherein said one or more parameters are sent in an encrypted form, and further wherein said one or more parameters facilitate said advertising system to track and analyze said interaction to at least one of:
detect a fraudulent activity by at least one of said user and said application; and
generate a statistical report to facilitate decision making regarding at least one of said one or more advertising content, said application, a developer of said application and said mobile communication device.

29. The computer program product of claim 28, wherein said one or more advertising content occupies an entire screen area of said display screen.

30. The computer program product of claim 28, wherein a size of portion of a display screen of said mobile communication device occupied by said one or more advertising content is specified in said advertising profile.

31. The computer program product of claim 28, wherein said event during activity of said application is one of a start of said application, an end of said application, before a splash screen display, after a splash screen display, a transition from said application to another application, and a transition back from another application to said application.

32. The computer program product of claim 28 further comprising instructions for retrieving said one or more advertising content from an advertisement system.

33. The computer program product of claim 28 further comprising instructions for retrieving said advertising profile from an advertisement system.

34. The computer program product of claim 28 further comprising instructions for receiving a call from said application on occurrence of said event.

35. The computer program product of claim 28 further comprising instructions for monitoring a status of said activity of said application to detect occurrence of said event.

36. The computer program product of claim 28, wherein said advertising profile includes at least one of a unique identifier for said application, a duration of displaying said advertising content, a choice of display type, a syntax string for requesting advertising content, a mobile communication device location, a mobile communication device OS, a mobile communication display screen size, hardware/software related parameters, and a parameter for checking type of said event.

37. The computer program product of claim 28, wherein said advertising profile can be specific to said user.

38. The computer program product of claim 28, wherein said plurality of parameters representative of said interaction between said user of said mobile communication device and said one or more advertising content being displayed on said mobile communication device include at least one of a mobile communication device identifier, a mobile communication device location, a mobile service provider, an internet provider, and a response of said user to said one or more advertising content.
